(19) United States
(12) Patent Application Publication
(10) Pub. No.: US 2025/0219545 A1
(43) Pub. Date: Jul. 3, 2025

(54) ISOLATED POWER CONVERTER WITH ADJUSTABLE CHARACTERISTIC OF A BODE PLOT AND RELATED ADJUSTMENT CIRCUIT

(71) Applicant: Leadtrend Technology Corp., Hsinchu County (TW)

(72) Inventors: Yi-Min Tzeng, Hsinchu County (TW); Ming-Chang Tsou, Hsinchu County (TW); Hsien-Te Huang, Hsinchu County (TW); Shih-Chieh Chou, Hsinchu County (TW)

(73) Assignee: Leadtrend Technology Corp., Hsinchu County (TW)

(21) Appl. No.: 18/909,942

(22) Filed: Oct. 9, 2024

(30) Foreign Application Priority Data
Dec. 27, 2023 (TW) 112151008

(51) Int. Cl. H02M 3/335

(52) U.S. Cl. CPC H02M 3/33507

(57) ABSTRACT

An adjustment circuit is included in a secondary-side controller, wherein the secondary-side controller is installed at a secondary side of an isolated power converter. The adjustment circuit includes a voltage divider, a buffer, a first variable resistor, a second variable resistor, an amplifier, and an N-type metal-oxide-semiconductor transistor. The buffer is coupled to the voltage divider. The first variable resistor is coupled to an external resistor outside the secondary-side controller. The second variable resistor is coupled to the first variable resistor and the buffer. The amplifier is coupled to the first variable resistor and the second variable resistor. The N-type metal-oxide-semiconductor transistor is coupled to a first external capacitor, a bias resistor, and an optocoupler. The first variable resistor and the second variable resistor adjust a characteristic of a Bode plot of the isolated power converter.

### BACKGROUND OF THE INVENTION

### 1. Field of the Invention

The present invention relates to an isolated power converter and a related adjustment circuit, and particularly to an isolated power converter and a related adjustment circuit that can change a characteristic of a Bode plot of the isolated power converter through components of the integrated circuits.

### 2. Description of the Prior Art

In the prior art, a control circuit on a secondary side of the AC/DC isolated power converter is composed of discrete components (e.g. resistors, capacitors, optocouplers, etc.), so after the AC/DC isolated power converter is produced, the discrete components have already been determined. That is to say, a characteristic of the control circuit is fixed after the AC/DC isolated power converter is produced. However, when the isolated power converter is designed to be applied to an application compliant with universal serial bus power delivery charging specification version 3.1 (USB PD 3.1) or other applications with a wide output voltage range, the AC/DC isolated power converter needs to operate at a wider output voltage range.

However, since the control circuit is composed of the discrete components (e.g. resistors, capacitors, optocouplers, etc.) and these discrete components cannot be changed after the AC/DC isolated power converter is produced, the control circuit may not be easily designed for the wider output voltage range when the AC/DC isolated power converter needs to operate at a wider output voltage range, resulting in the AC/DC isolated power converter not being able to ensure good response characteristics in wide output voltage range. Therefore, how to make the response characteristic of the AC/DC isolated power converter not easily affected by the wide output voltage range has become an important issue for a designer of the control circuit.

### SUMMARY OF THE INVENTION

An embodiment of the present invention provides an adjustment circuit, wherein the adjustment circuit is included in a secondary-side controller, and the secondary-side controller is installed at a secondary side of an isolated power converter. The adjustment circuit includes a voltage divider, a buffer, a first variable resistor, a second variable resistor, an amplifier and an N-type metal-oxide-semiconductor transistor. The buffer is coupled to the voltage divider. The first variable resistor is coupled to an external resistor installed outside the secondary-side controller. The second variable resistor is coupled to the first variable resistor and the buffer. The amplifier is coupled to the first variable resistor and the second variable resistor. The N-type metal-oxide-semiconductor transistor is coupled to the amplifier and a first external capacitor, a bias resistor and an optocoupler installed outside the secondary-side controller. The first variable resistor and the second variable resistor are used for adjusting a characteristic of a Bode plot of the isolated power converter.

Another embodiment of the present invention provides an adjustment circuit, wherein the adjustment circuit is included in a secondary-side controller, and the secondary-side controller is installed at a secondary side of an isolated power converter. The adjustment circuit includes a voltage divider, a variable resistor, an amplifier and an N-type metal oxide semi-transistor. The variable resistor is coupled to an external resistor installed outside the secondary-side controller and the voltage divider. The amplifier is coupled to the variable resistor and the voltage divider. The N-type metal oxide semi-transistor is coupled to the amplifier and a first external capacitor, a bias resistor and an optocoupler installed outside the secondary-side controller. The variable resistor is used for adjusting a characteristic of a Bode plot of the isolated power converter.

Another embodiment of the present invention provides an isolated power converter with adjustable characteristic of a Bode plot. The isolated power converter includes a secondary-side controller, wherein the secondary-side controller is installed at a secondary side of the isolated power converter and controls the secondary side of the isolated power converter to receive energy from a primary side of the isolated power converter and generate an output voltage accordingly, and the secondary-side controller includes an adjustment circuit. The adjustment circuit includes a voltage divider, a buffer, a first variable resistor, a second variable resistor, an amplifier and an N-type metal-oxide-semiconductor transistor. The buffer is coupled to the voltage divider. The first variable resistor is coupled to an external resistor installed outside the secondary-side controller. The second variable resistor is coupled to the first variable resistor and the buffer. The amplifier is coupled to the first variable resistor and the second variable resistor. The N-type metal oxide semi-transistor is coupled to the amplifier and a first external capacitor, a bias resistor and an optocoupler installed outside the secondary-side controller. The first variable resistor and the second variable resistor are used for adjusting the characteristic of the Bode plot.

Another embodiment of the present invention provides an isolated power converter with adjustable characteristic of a Bode plot. The isolated power converter includes a secondary-side controller, wherein the secondary-side controller is installed at a secondary side of the isolated power converter and controls a secondary side of the isolated power converter to receive energy from a primary side of the isolated power converter and generate an output voltage accordingly, and the secondary-side controller includes an adjustment circuit. The adjustment circuit includes a voltage divider, a variable resistor, an amplifier and an N-type metal oxide semi-transistor. The variable resistor is coupled to an external resistor installed outside the secondary-side controller and the voltage divider. The amplifier coupled to the variable resistor and the voltage divider. The N-type metal oxide semi-transistor coupled to the amplifier and a first external capacitor, a bias resistor and an optocoupler installed outside the secondary-side controller. The variable resistor is used for adjusting the characteristic of the Bode plot.

The present invention provides an adjustment circuit and an isolated power converter with adjustable characteristic of a Bode plot. Because the adjustment circuit and the isolated power converter can change a characteristic of the Bode plot (corresponding to frequency response of the isolated power converter) of the isolated power converter through components of the secondary-side controller (integrated circuits), compared to the prior art, when the isolated power converter needs to operate in wider range of an output voltage, the isolated power converter can adjust the characteristic of the Bode plot of the isolated power converter according to different operating conditions to ensure that the isolated power converter will have certain response characteristics under a wide range of the output voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a secondary-side controller applied to an isolated power converter according to a first embodiment of the present invention.

FIG. 2 is a diagram illustrating gain of the Bode plot vs. an operational frequency of the isolated power converter and phase of the Bode plot vs. the operational frequency of the isolated power converter when the resistance of the second variable resistor is changed.

FIG. 3 is a diagram illustrating the gain of the Bode plot vs. the operational frequency of the isolated power converter and the phase of the Bode plot vs. the operational frequency of the isolated power converter when the resistance of the first variable resistor is changed.

FIG. 4 is a diagram illustrating the first variable resistor and the second variable resistor.

FIG. 5 is a diagram illustrating a secondary-side controller applied to the isolated power converter according to a second embodiment of the present invention.

FIG. 6 is a diagram illustrating the gain of the Bode plot vs. the operational frequency of the isolated power converter and the phase of the Bode plot vs. the operational frequency of the isolated power converter when the resistance RS of the first variable resistor is changed.

### DETAILED DESCRIPTION

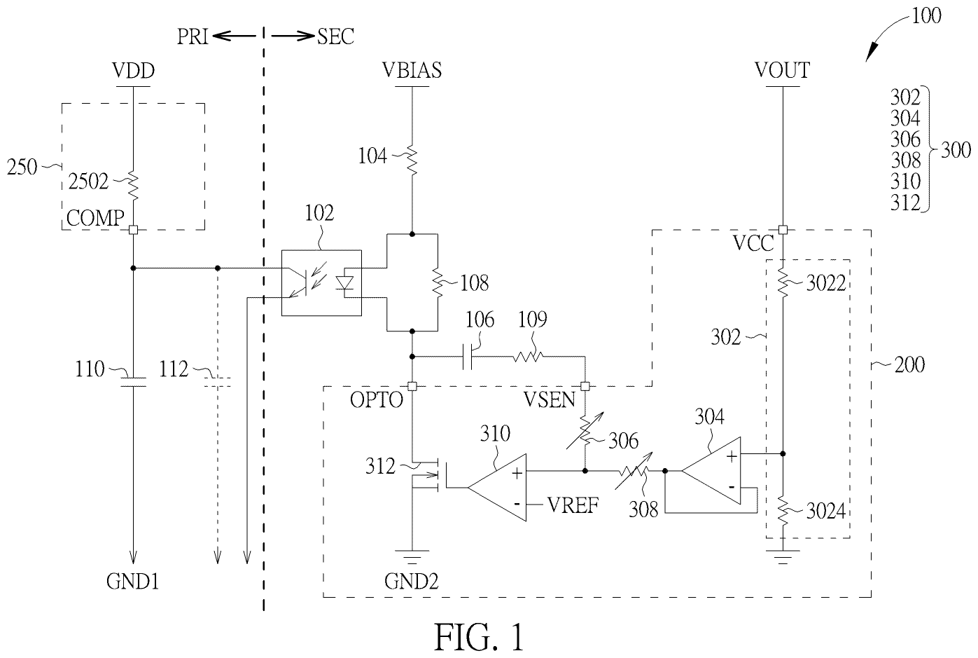

Please refer to FIG. 1. FIG. 1 is a diagram illustrating a secondary-side controller 200 applied to an isolated power converter 100 according to a first embodiment of the present invention, wherein the secondary-side controller 200 includes an adjustment circuit 300, and the secondary-side controller 200 is installed at a secondary side SEC of the isolated power converter 100. As shown in FIG. 1, the adjustment circuit 300 includes a voltage divider 302, a buffer 304, a first variable resistor 306, a second variable resistor 308, an amplifier 310 and an N-type metal-oxide-semiconductor transistor 312, the voltage divider 302 includes a first resistor 3022 and a second resistor 3024, wherein coupling relationships between the voltage divider 302, the buffer 304, the first variable resistor 306, the second variable resistor 308, the amplifier 310, the N-type metal-oxide-semiconductor transistor 312, the first resistor 3022 and the second resistor 3024 can be referred to FIG. 1, so further description thereof is omitted for simplicity. In addition, potential GND1 of ground of a primary side PRI of the isolated power converter 100 is different from potential GND2 of ground of the secondary side SEC of the isolated power converter 100. In addition, because the present invention relates to the adjustment circuit 300, for simplifying FIG. 1, in FIG. 1, the primary side PRI of the isolated power converter 100, the secondary side SEC of the isolated power converter 100, the secondary-side controller 200 and a primary-side controller 250 installed at the primary side PRI of the isolated power converter 100 only show components related to the present invention. That is to say, the primary side PRI of the isolated power converter 100, the secondary side SEC of the isolated power converter 100, the secondary-side controller 200 and the primary-side controller 250 are not limited to those components shown in FIG. 1. In addition, the amplifier 310 and the N-type metal-oxide-semiconductor transistor 312 are used for simulating a behavior of a TL431 (precision voltage reference IC), and the secondary-side controller 200 and the primary-side controller 250 are integrated circuits. In addition, as shown in FIG. 1, an optocoupler 102 for isolating the primary side PRI of the isolated power converter 100 and the secondary side SEC of the isolated power converter 100, a resistor 104 coupled to the optocoupler 102, a first external capacitor 106 coupled to the secondary-side controller 200, a bias resistor 108, an external resistor 109 and a second external capacitor 110 coupled to the optocoupler 102 are discrete components on a printed circuit board, wherein the isolated power converter 100, the secondary-side controller 200 and the primary-side controller 250 are installed on the printed circuit board. In addition, coupling relationships between the secondary-side controller 200 and the optocoupler 102, the resistor 104, the first external capacitor 106, the bias resistor 108 and the external resistor 109 outside the secondary-side controller 200 can be referred to FIG. 1, so further description thereof is omitted for simplicity. In addition, as shown in FIG. 1, the optocoupler 102, the first external capacitor 106 and the bias resistor 108 are coupled to the secondary-side controller 200 through a pin OPTO, the external resistor 109 is coupled to the secondary-side controller 200 through a pin VSEN, and the secondary-side controller 200 is coupled to an output terminal of the secondary side SEC of the isolated power converter 100 through a pin VCC, wherein the output terminal has an output voltage VOUT. In addition, as shown in FIG. 1, VDD is a supply voltage of the primary-side controller 250 and the resistor 104 is coupled to a bias VBIAS. In addition, as shown in FIG. 1, the amplifier 310 is further used for receiving a reference voltage VREF.

To describe how the adjustment circuit 300 adjusts a characteristic of a Bode plot of the isolated power converter 100 through the secondary-side controller 200, taking that the adjustment circuit 300 is a Type 2 compensator as an example, wherein the Bode plot of the isolated power converter 100 (corresponding to the Type 2 compensator) has two poles and one zero, and a transfer function G(s) of the adjustment circuit 300 can be represented by equation (1):

$$G ( s ) = C T R \times \frac{{R}_{p u l l u p}}{{R}_{L E D}} \times \frac{{R}_{d n}}{{R}_{u p} + {R}_{d n}} \times \frac{1 + s {C}_{1} ( {R}_{s} + {R}_{2} )}{( s {R}_{i} {C}_{1} ) ( 1 + s {R}_{p u l lup} ( {C}_{2} + {C}_{o p t o} ) )} \qquad ( 1 )$$

wherein in equation (1):
CTR is a current transfer ratio of the optocoupler 102;
Rₚᵤₗₗᵤₚ is a resistance of a pull-up resistor 2502 coupled to a pin COMP of the primary-side controller 250 of the primary side PRI of the isolated power converter 100;
R_{LED} is a resistance of a resistor 104 coupled to the optocoupler 102;
Rᵤₚ is a resistance of the first resistor 3022;
R_{dn} is a resistance of the second resistor 3024;
Rₛ is a resistance of the first variable resistor 306;
R₁ is a resistance of the second variable resistor 308;
R₂ is a resistance of the external resistor 109;
C₁ is a capacitance of the first external capacitor 106;
C₂ is a capacitance of the second external capacitor 110; and
Cₒₚₜₒ is a capacitance of a parasitic capacitor 112 of the optocoupler 102.

According to equation (1), a zeroth pole ωₚ₀, a first pole ωₚ₁ and a zero ω_{z1} of the Bode plot can be represented by equation (2), equation (3) and equation (4), respectively:

$${ω}_{p 0} = \frac{1}{{R}_{i} {C}_{1}} \qquad ( 2 )$$

$${ω}_{p 1} = \frac{1}{{R}_{P u l l u p} ( {C}_{2} + {C}_{o p t o} )} \qquad ( 3 )$$

$${ω}_{z 1} = \frac{1}{{C}_{1} ( {R}_{s} + {R}_{2} )} \qquad ( 4 )$$

Afterward, frequencies corresponding to the zeroth pole ωₚ₀, the first pole ωₚ₁ and the zero ω_{z1} can be represented by equation (5), equation (6) and equation (7), respectively:

$${f}_{p 0} = \frac{{ω}_{p 0}}{2 π} \qquad ( 5 )$$

$${f}_{p 1} = \frac{{ω}_{p 1}}{2 π} \qquad ( 6 )$$

$${f}_{z 1} = \frac{{ω}_{z 1}}{2 π} \qquad ( 7 )$$

Because the optocoupler 102, the resistor 104, the first external capacitor 106, the external resistor 109 and the second external capacitor 110 are discrete components on the printed circuit board, the capacitance Cₒₚₜₒ of the parasitic capacitor 112, the resistance R_{LED} of the resistor 104, the capacitance C₁ of the first external capacitor 106, the resistance R₂ of the external resistor 109 and the capacitance C₂ of the second external capacitor 110 are not changed after a manufacturer installs the isolated power converter 100, the secondary-side controller 200 and the primary-side controller 250 on the printed circuit board. Therefore, compared to the prior art, according to FIG. 1, equation (2), equation (3) and equation (4), it is very obvious that the adjustment circuit 300 can determine positions of poles and zero of the Bode plot through the resistance Rₛ of the first variable resistor 306 and the resistance Rᵢ of the second variable resistor 308. That is to say, the adjustment circuit 300 can adjust a characteristic of frequency response of the isolated power converter 100 through the resistance Rₛ of the first variable resistor 306 and the resistance Rᵢ of the second variable resistor 308.

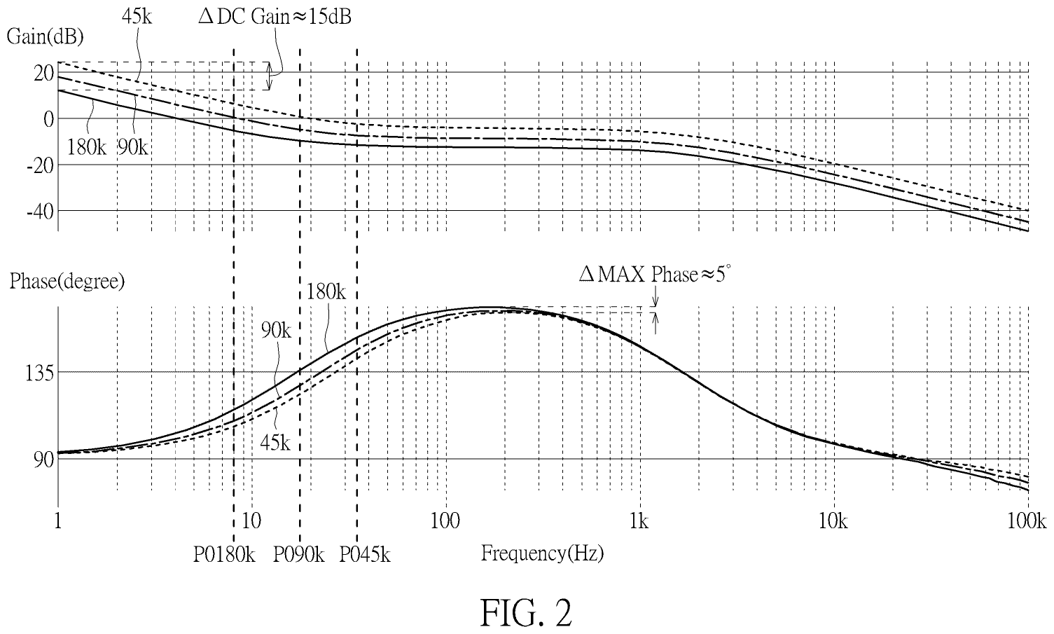

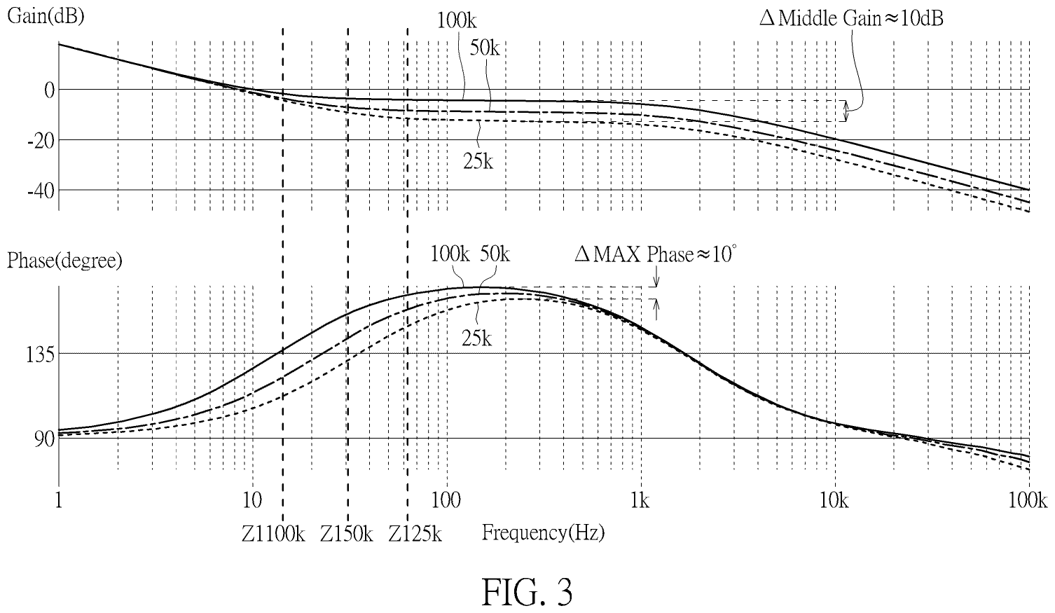

Please refer to FIG. 2 and FIG. 3. FIG. 2 is a diagram illustrating gain of the Bode plot vs. an operational frequency of the isolated power converter 100 and phase of the Bode plot vs. the operational frequency of the isolated power converter 100 when the resistance Rᵢ of the second variable resistor 308 is changed, and FIG. 3 is a diagram illustrating the gain of the Bode plot vs. the operational frequency of the isolated power converter 100 and the phase of the Bode plot vs. the operational frequency of the isolated power converter 100 when the resistance Rₛ of the first variable resistor 306 is changed. Taking the resistance Rᵢ being 180 kΩ, 90 kΩ, 45 kΩ as an example, according to equation (2), it is very obvious that

$${ω}_{p 0} ( = \frac{1}{{R}_{i} {C}_{1}} )$$

is reduced with increase of the resistance Rᵢ, and according to equation (5), it is also obvious that

$${f}_{p 0} ( = \frac{{ω}_{p 0}}{2 π} )$$

is also reduced with increase of the resistance Rᵢ, so as shown in FIG. 2, variation of the resistance Rᵢ will change a position of the zeroth pole ωₚ₀, resulting in DC gain of the Bode plot and phase of the Bode plot being also changed with variation of the resistance Rᵢ, wherein maximum variation ΔDC Gain of the DC gain is about 15 dB and maximum variation ΔMAX Phase of the phase is about 5 degree.

In addition, taking the resistance Rₛ being 100 kΩ, 50 kΩ, 25 kΩ as an example, according to equation (4), it is very clear that

$${ω}_{z 1} = \frac{1}{{C}_{1} ( {R}_{s} + {R}_{2} )}$$

is reduced with increase of the resistance Rₛ, and according to equation (7), it is very also clear that

$${f}_{z 1} = \frac{{ω}_{z 1}}{2 π}$$

is reduced with increase of the resistance Rₛ, so as shown in FIG. 3, variation of the resistance Rₛ will change a position of a frequency corresponding to the zero ω_{z1}, resulting in middle gain of the Bode plot and the phase of the Bode plot being also changed with variation of the resistance Rₛ, wherein maximum variation Δmiddle Gain of the middle gain is about 10 dB and maximum variation ΔMAX Phase of the phase is about 10 degrees.

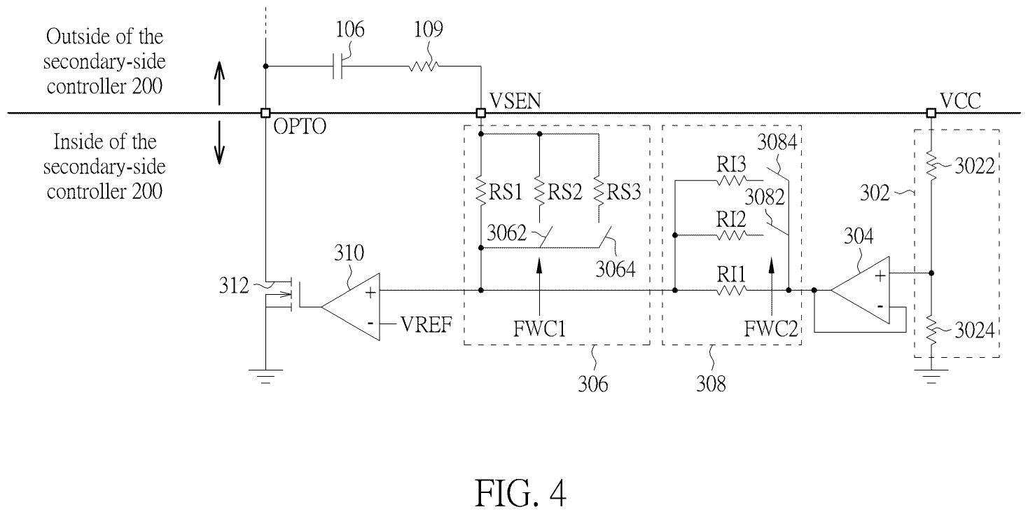

Please refer to FIG. 4. FIG. 4 is a diagram illustrating the first variable resistor 306 and the second variable resistor 308, wherein the first variable resistor 306 includes resistors RS1-RS3 and switches 3062, 3064, the second variable resistor 308 includes resistors RI1-RI3 and switches 3082, 3084, and the adjustment circuit 300 can adjust the resistance Rₛ of the first variable resistor 306 through a first control signal FWC1 and adjust the resistance Rᵢ of the second variable resistor 308 through a second control signal FWC2. Therefore, taking the first variable resistor 306 as an example, when the first control signal FWC1 is enabled, and the first control signal FWC1 makes the switch 3062 turned on and the switch 3064 turned off, the resistance Rₛ of the first variable resistor 306 is equal to a resistance by paralleling the resistor RS1 and the resistor RS2. In addition, taking the second variable resistor 308 as an example, when the second control signal FWC2 is enabled and the second control signal FWC2 makes the switches 3082, 3084 turned on, the resistance Rᵢ of the second variable resistor 308 is equal to a resistance by paralleling the resistor RI1, the resistor RI2 and the resistor RI3. In addition, the present invention is not limited to configurations of the first variable resistor 306 and the second variable resistor 308 shown in FIG. 4. That is to say, any adjusting the resistance Rₛ of the first variable resistor 306 and the resistance Rᵢ of the second variable resistor 308 by control signal falls within the scope of the present invention.

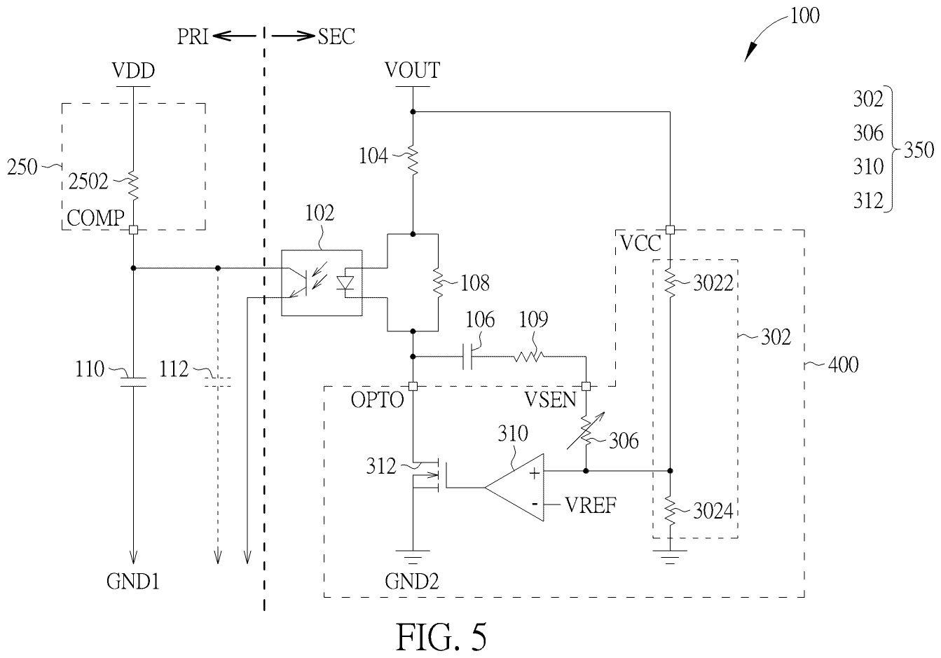

Please refer to FIG. 5. FIG. 5 is a diagram illustrating a secondary-side controller 400 applied to the isolated power converter 100 according to a second embodiment of the present invention, wherein the secondary-side controller 400 includes an adjustment circuit 350. As shown in FIG. 5, a difference between the adjustment circuit 350 and the adjustment circuit 300 is that the adjustment circuit 350 includes the voltage divider 302, the first variable resistor 306, the amplifier 310 and the N-type metal-oxide-semiconductor transistor 312, wherein coupling relationships between the voltage divider 302, the first variable resistor 306, the amplifier 310, the N-type metal-oxide-semiconductor transistor 312, the first resistor 3022 and the second resistor 3024 can be referred to FIG. 5, so further description thereof is omitted for simplicity. In addition, the configurations of the first variable resistor 306 can be referred to FIG. 4, so further description thereof is also omitted for simplicity.

Next, a transfer function G(s) of the adjustment circuit 350 can be represented by equation (8):

$$G ( s ) = C T R \times \frac{{R}_{p u l l u p}}{{R}_{L E D}} \times \frac{1 + s {C}_{1} ( {R}_{s} + {R}_{2} )}{( s {R}_{1} {C}_{1} ) ( 1 + s {R}_{p u l l u p} ( {C}_{2} + {C}_{opto} ) )} \qquad ( 8 )$$

wherein in equation (8):
CTR is the current transfer ratio of the optocoupler 102;
Rₚᵤₗₗᵤₚ is the resistance of the pull-up resistor 2502;
R_{LED} is the resistance of the resistor 104;
R₁ is the resistance of the first resistor 3022;
Rₛ is the resistance of the first variable resistor 306;
R₂ is the resistance of the external resistor 109;
C₁ is the capacitance of the first external capacitor 106;
C₂ is the capacitance of the second external capacitor 110; and
Cₒₚₜₒ is the capacitance of the parasitic capacitor 112 of the optocoupler 102.

According to equation (8), a zeroth pole ωₚ₀, a first pole ωₚ₁ and a zero ω_{z1} of the Bode plot of the isolated power converter 100 can be represented by equation (9), equation (10) and equation (11), respectively:

$${ω}_{p 0} = \frac{1}{{R}_{1} {C}_{1}} \qquad ( 9 )$$

$${ω}_{p 1} = \frac{1}{{R}_{P u l l u p} ( {C}_{2} + {C}_{o p t o} )} \qquad ( 10 )$$

$${ω}_{z 1} = \frac{1}{{C}_{1} ( {R}_{1} + {R}_{s} + {R}_{2} )} \qquad ( 11 )$$

Afterward, frequencies corresponding to the zeroth pole ωₚ₀, the first pole ωₚ₁ and the zero ω_{z1} can be represented by equation (5), equation (6) and equation (7), respectively.

Similarly, according to FIG. 5, equation (9), equation (10) and equation (11), it is very obvious that if the resistance R₁ of the first resistor 3022 is a fixed value, compared to the prior art, the adjustment circuit 350 can still determine a position of the zero ω_{z1} of the Bode plot through the resistance Rₛ of the first variable resistor 306. That is to say, the adjustment circuit 350 can adjust a characteristic of the Bode plot through the resistance Rₛ of the first variable resistor 306.

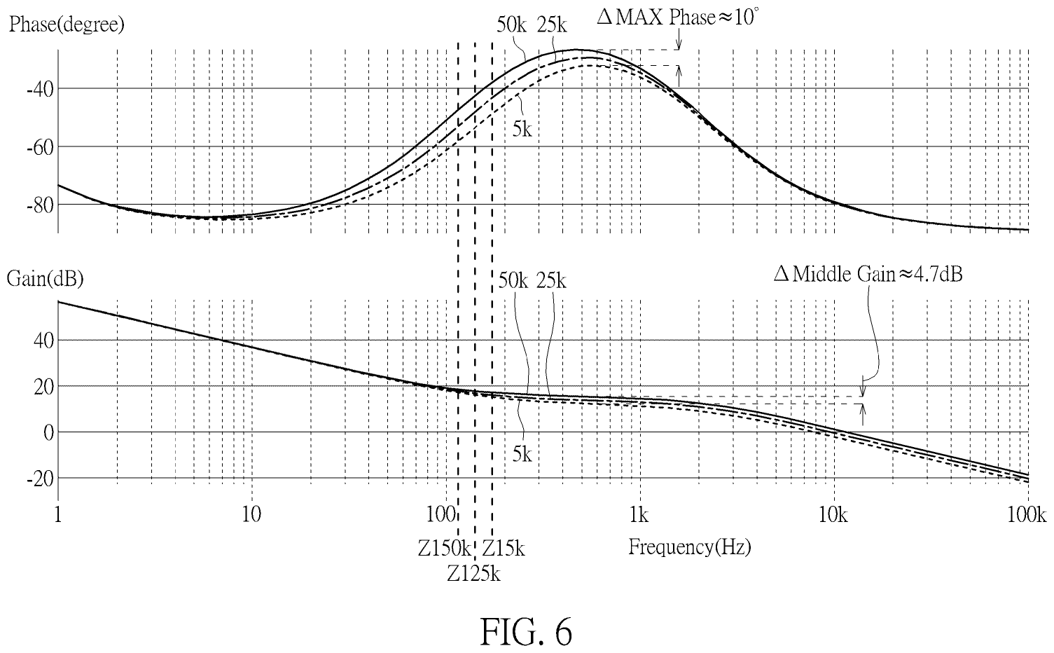

Therefore, please refer to FIG. 6. FIG. 6 is a diagram illustrating the gain of the Bode plot vs. the operational frequency of the isolated power converter 100 and the phase of the Bode plot vs. the operational frequency of the isolated power converter 100 when the resistance Rₛ of the first variable resistor 306 is changed. Taking the resistance Rₛ being 50 kΩ, 25 kΩ, 5 kΩ as an example, according to equation (11), it is very obvious that

$${ω}_{z 1} = \frac{1}{{C}_{1} ( {R}_{1} + {R}_{s} + {R}_{2} )}$$

is reduced with increase of the resistance Rₛ, and according to equation (7), it is very obvious that,

$${f}_{z 1} = \frac{{ω}_{z 1}}{2 π}$$

is also reduced with increase of the resistance Rₛ, so as shown in FIG. 6, variation of the resistance Rₛ will change a position of the zero ω_{z1}, resulting in the middle gain of the Bode plot and the phase of the Bode plot being also changed with variation of the resistance Rₛ, wherein the maximum variation Δmiddle Gain of the middle gain is about 4.7 dB and maximum variation ΔMAX Phase of the phase is about 10 degrees.

To sum up, because the adjustment circuit and the isolated power converter provided by the present invention can change the characteristic of the Bode plot (corresponding to frequency response of the isolated power converter) of the isolated power converter through components of the secondary-side controller (the integrated circuits), compared to the prior art, when the isolated power converter needs to operate in wider range of the output voltage, a compensator provided by the prior art cannot have the same characteristic in very range of the output voltage. However, the present invention can make the frequency response of the isolated power converter be relatively unaffected, so that the stable characteristic of the frequency response can be maintained under wider range of the output voltages of the isolated power converter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An adjustment circuit, wherein the adjustment circuit is comprised in a secondary-side controller, and the secondary-side controller is installed at a secondary side of an isolated power converter, the adjustment circuit comprising:
a voltage divider;
a buffer coupled to the voltage divider;
a first variable resistor coupled to an external resistor installed outside the secondary-side controller;
a second variable resistor coupled to the first variable resistor and the buffer;
an amplifier coupled to the first variable resistor and the second variable resistor; and
an N-type metal-oxide-semiconductor transistor coupled to the amplifier and a first external capacitor, a bias resistor and an optocoupler installed outside the secondary-side controller;
wherein the first variable resistor and the second variable resistor are used for adjusting a characteristic of a Bode plot of the isolated power converter.

2. The adjustment circuit of claim 1, wherein the voltage divider comprises:
a first resistor coupled to an output terminal of the secondary side of the isolated power converter and the buffer; and
a second resistor coupled to the first resistor, the buffer and ground.

3. The adjustment circuit of claim 2, wherein a transfer function G(s) of the Bode plot is:
$$G ( s ) = C T R \times \frac{{R}_{p u l l u p}}{{R}_{L E D}} \times \frac{{R}_{d n}}{{R}_{u p} + {R}_{d n}} \times \frac{1 + s {C}_{1} ( {R}_{s} + {R}_{2} )}{( s {R}_{i} {C}_{1} ) ( 1 + s {R}_{p u l lup} ( {C}_{2} + {C}_{o p t o} ) )} ;$$
wherein:
CTR is a current transfer ratio of the optocoupler;
Rₚᵤₗₗᵤₚ is a resistance of a pull-up resistor coupled to a compensation pin of a primary-side controller of a primary side of the isolated power converter;
R_{LED} is a resistance of a resistor coupled to the optocoupler;
Rᵤₚ is a resistance of the first resistor of the voltage divider;
R_{dn} is a resistance of the second resistor of the voltage divider;
Rₛ is a resistance of the first variable resistor;
R₁ is a resistance of the second variable resistor;
R₂ is a resistance of the external resistor;
C₁ is a capacitance of the first external capacitor;
C₂ is a capacitance of a second external capacitor coupled to the compensation pin and the optocoupler; and
Cₒₚₜₒ is a capacitance of a parasitic capacitor of the optocoupler.

4. The adjustment circuit of claim 3, wherein:
$${ω}_{p 0} = \frac{1}{{R}_{i} {C}_{1}}$$
is a zeroth pole of the transfer function G(s);
$${ω}_{p 1} = \frac{1}{{R}_{P u l l u p} ( {C}_{2} + {C}_{o p t o} )}$$
is a first pole of the transfer function G(s); and
$${ω}_{z 1} = \frac{1}{{C}_{1} ( {R}_{s} + {R}_{2} )}$$
is a zero of the transfer function G(s).

5. The adjustment circuit of claim 1, wherein the secondary-side controller is an integrated circuit.

6. The adjustment circuit of claim 1, wherein the first variable resistor and the second variable resistor adjust the characteristic of the Bode plot through positions of poles and zero of the Bode plot.

7. An adjustment circuit, wherein the adjustment circuit is comprised in a secondary-side controller, and the secondary-side controller is installed at a secondary side of an isolated power converter, the adjustment circuit comprising:
a voltage divider;
a variable resistor coupled to an external resistor installed outside the secondary-side controller and the voltage divider;
an amplifier coupled to the variable resistor and the voltage divider; and
an N-type metal oxide semi-transistor coupled to the amplifier and a first external capacitor, a bias resistor and an optocoupler installed outside the secondary-side controller;
wherein the variable resistor is used for adjusting a characteristic of a Bode plot of the isolated power converter.

8. The adjustment circuit of claim 7, wherein the voltage divider comprises:
a first resistor coupled to an output terminal of the secondary side of the isolated power converter, the variable resistor and the amplifier; and
a second resistor coupled to the first resistor, the variable resistor, the amplifier and ground.

9. The adjustment circuit of claim 8, wherein a transfer function G(s) of the Bode plot is:
$$G ( s ) = C T R \times \frac{{R}_{p u l l u p}}{{R}_{L E D}} \times \frac{1 + s {C}_{1} ( {R}_{s} + {R}_{2} )}{( s {R}_{1} {C}_{1} ) ( 1 + s {R}_{p u l lup} ( {C}_{2} + {C}_{o p t o} ) )} ;$$
wherein:
CTR is a current transfer ratio of the optocoupler;
Rₚᵤₗₗᵤₚ is a resistance of a pull-up resistor coupled to a compensation pin of a primary-side controller of a primary side of the isolated power converter;
R_{LED} is a resistance of a resistor coupled to the optocoupler;
R₁ is a resistance of the first resistor of the voltage divider;
Rₛ is a resistance of the variable resistor;
R₂ is a resistance of the external resistor;
C₁ is a capacitance of the first external capacitor;
C₂ is a capacitance of a second external capacitor coupled to the compensation pin and the optocoupler; and
Cₒₚₜₒ is a capacitance of a parasitic capacitance of the optocoupler.

10. The adjustment circuit of claim 9, wherein:
$${ω}_{p 0} = \frac{1}{{R}_{1} {C}_{1}}$$
is a zeroth pole of the transfer function G(s);
$${ω}_{p 1} = \frac{1}{{R}_{P u l l u p} ( {C}_{2} + {C}_{o p t o} )}$$
is a first pole of the transfer function G(s); and
$${ω}_{z 1} = \frac{1}{{C}_{1} ( {R}_{1} + {R}_{s} + {R}_{2} )}$$
is a zero of the transfer function G(s).

11. The adjustment circuit of claim 7, wherein the secondary-side controller is an integrated circuit.

12. The adjustment circuit of claim 7, wherein the variable resistor adjusts the characteristic of the Bode plot through a position of zero of the Bode plot.

13. An isolated power converter with adjustable characteristic of a Bode plot, comprising:
a secondary-side controller installed at a secondary side of the isolated power converter and controlling the secondary side of the isolated power converter to receive energy from a primary side of the isolated power converter and generate an output voltage accordingly, wherein the secondary-side controller comprises:
an adjustment circuit, comprising:
a voltage divider;
a buffer coupled to the voltage divider;
a first variable resistor coupled to an external resistor installed outside the secondary-side controller;
a second variable resistor coupled to the first variable resistor and the buffer;
an amplifier coupled to the first variable resistor and the second variable resistor; and
an N-type metal oxide semi-transistor coupled to the amplifier and a first external capacitor, a bias resistor and an optocoupler installed outside the secondary-side controller;
wherein the first variable resistor and the second variable resistor are used for adjusting the characteristic of the Bode plot.

14. The isolated power converter of claim 13, further comprising:
a primary-side controller installed at the primary side of the isolated power converter and controlling the primary side of the isolated power converter to transmit the energy of the primary side of the isolated power converter to the secondary side of the isolated power converter.

15. The isolated power converter of claim 13, wherein the secondary-side controller is an integrated circuit.

16. The isolated power converter of claim 13, wherein the first variable resistor and the second variable resistor adjust the characteristic of the Bode plot through positions of poles and zero of the Bode plot.

17. An isolated power converter with adjustable characteristic of a Bode plot, comprising:
a secondary-side controller installed at a secondary side of the isolated power converter and controlling a secondary side of the isolated power converter to receive energy from a primary side of the isolated power converter and generate an output voltage accordingly, wherein the secondary-side controller comprises:
an adjustment circuit, comprising:
a voltage divider;
a variable resistor coupled to an external resistor installed outside the secondary-side controller and the voltage divider;
an amplifier coupled to the variable resistor and the voltage divider; and
an N-type metal oxide semi-transistor coupled to the amplifier and a first external capacitor, a bias resistor and an optocoupler installed outside the secondary-side controller;
wherein the variable resistor is used for adjusting the characteristic of the Bode plot.

18. The isolated power converter of claim 17, further comprising:
a primary-side controller installed at the primary side of the isolated power converter and controlling the primary side of the isolated power converter to transmit the energy of the primary side of the isolated power converter to the secondary side of the isolated power converter.

19. The isolated power converter of claim 17, wherein the secondary-side controller is an integrated circuit.

20. The isolated power converter of claim 17, wherein the variable resistor adjusts the characteristic of the Bode plot through a position of zero of the Bode plot.
